(19) United States
(12) Patent Application Publication
(10) Pub. No.: US 2006/0102135 A1
(43) Pub. Date: May 18, 2006

(54) Torque improved engine or T.I.E

(76) Inventor: Michael Elman Johnson, Moncks Corner, SC (US)

Correspondence Address: Michael E. Johnson, 212 AIRBORNE WAY, CROSS, SC, 29436, US

(21) Appl. No.: 10/989,802

(22) Filed: Nov. 17, 2004

(51) Int. Cl. F02B 75/32

(52) U.S. Cl. 123/197.1

(57) ABSTRACT

An internal combustion engine that replaces the throw journal of a crankshaft with a contour that is dynamic rather than static. The contour is such that three cycles of engine operation is not affected, i.e. exhaust, intake, and compression. The contour deviates only during the power stroke where an increased incidence to the circular for approximately ninety degrees of rotation is incorporated. This defers from previous attempts by eliminating complex geometries such as epitrochoidal, sinusoidal, or the elliptical that by their nature negatively affect the exhaust, intake, and compression strokes of the Otto cycle when compared to the traditional crankshaft. Additionally, the deviation from the circular orbit during the power cycle optimizes to a larger extent the leverage available for peak thermodynamic pressures in the cylinder in the brief optimum time afforded by that pressure. Compressors so configured would also be more efficient by reducing the energy requirements of an input shaft.

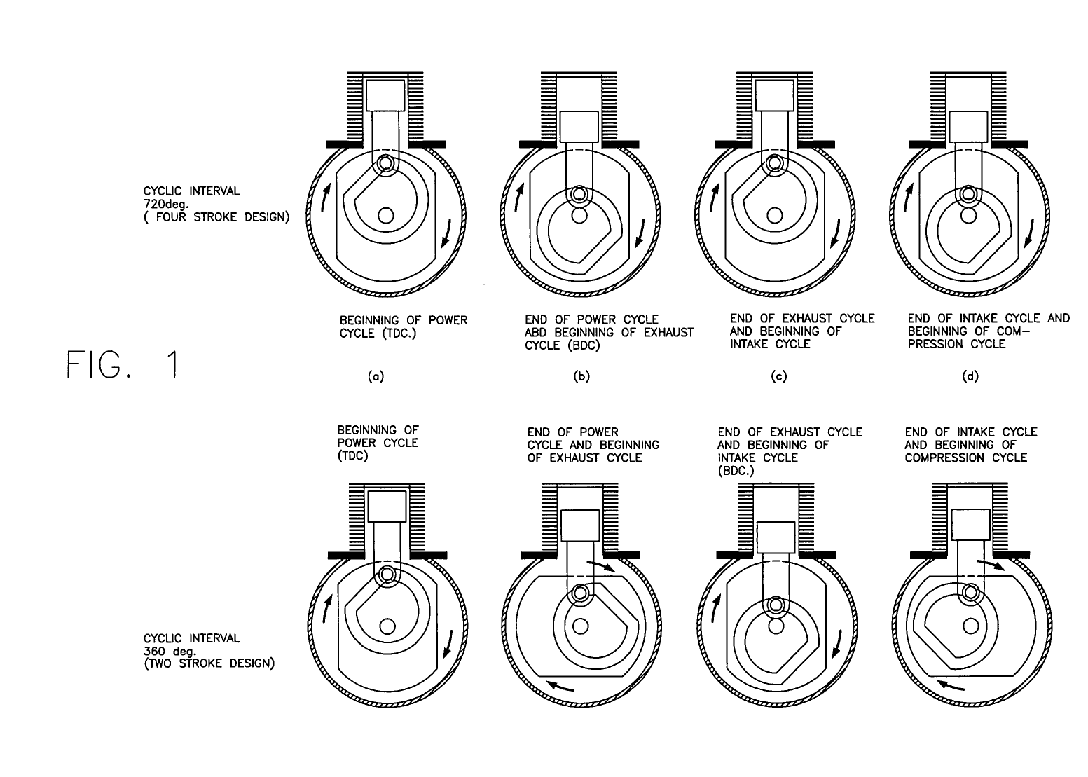

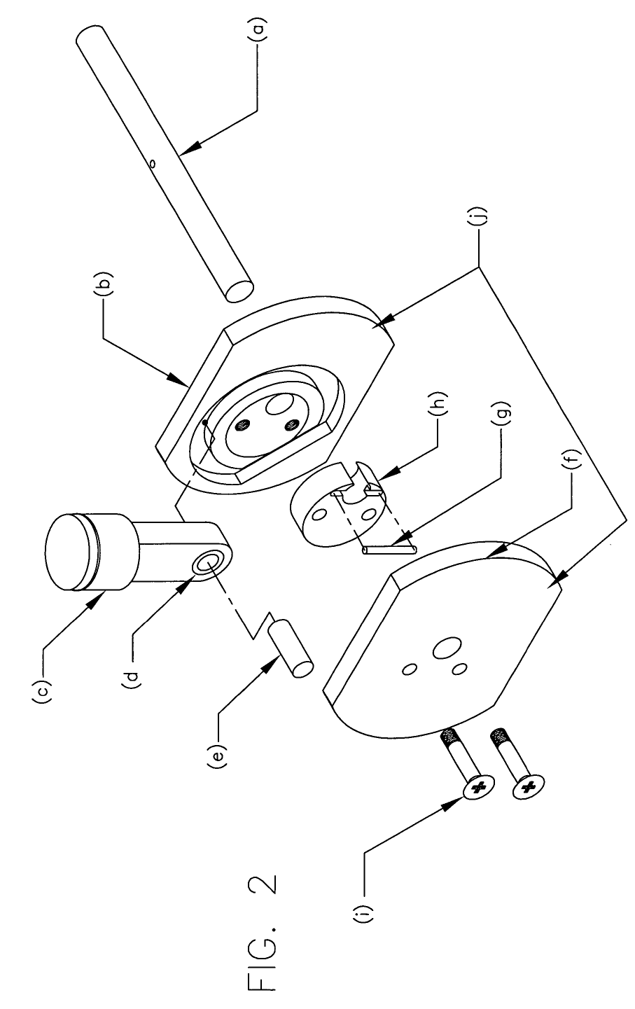

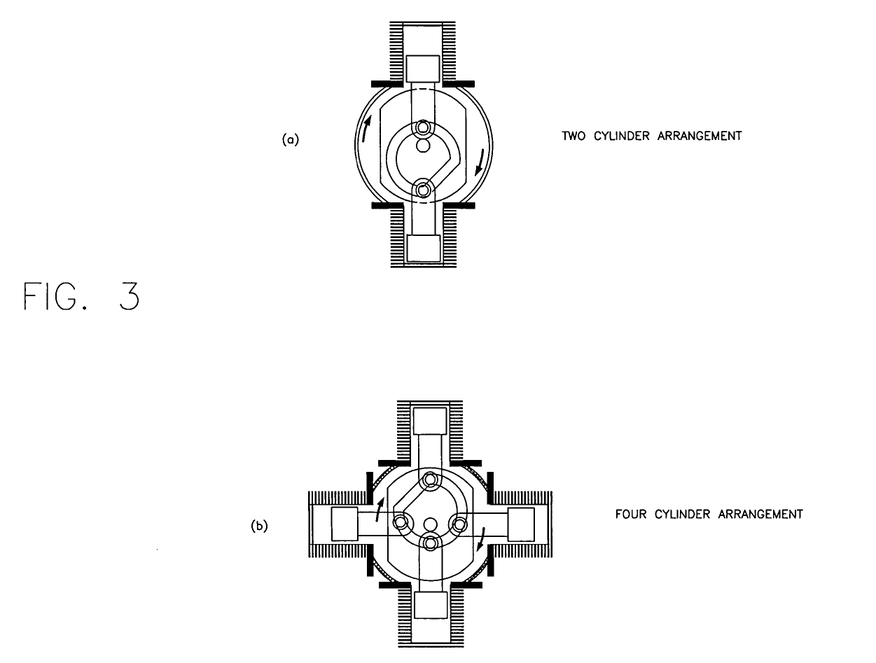

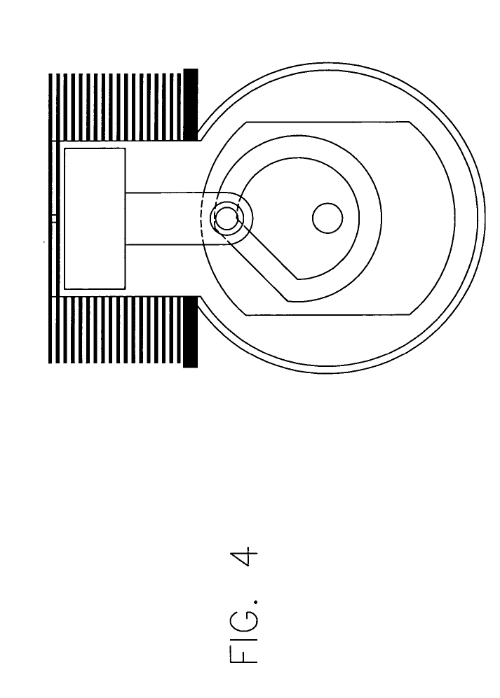

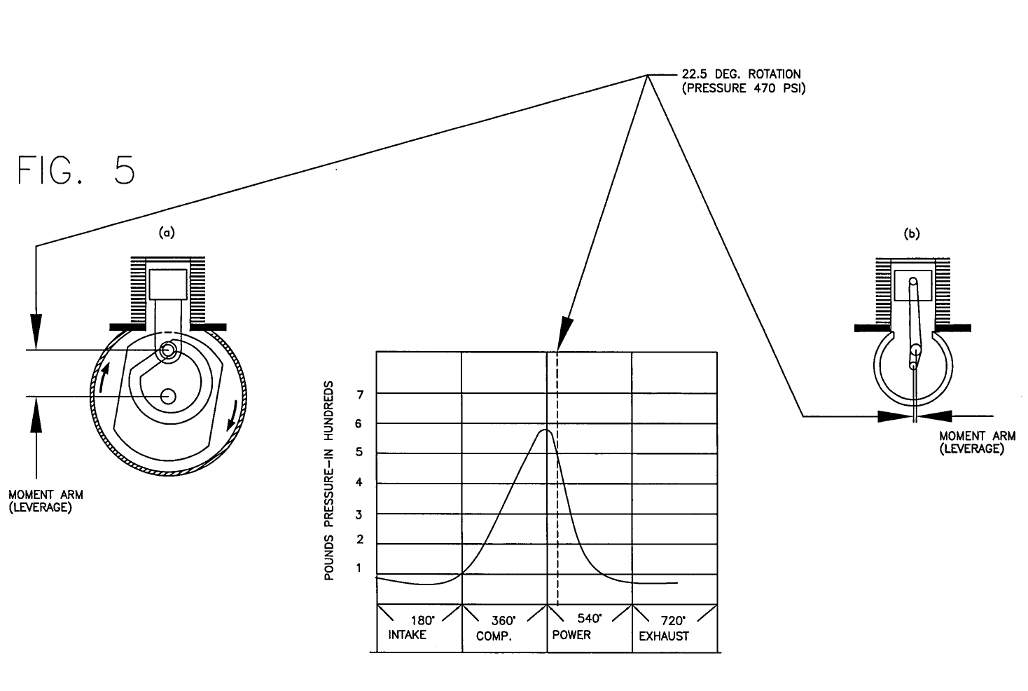

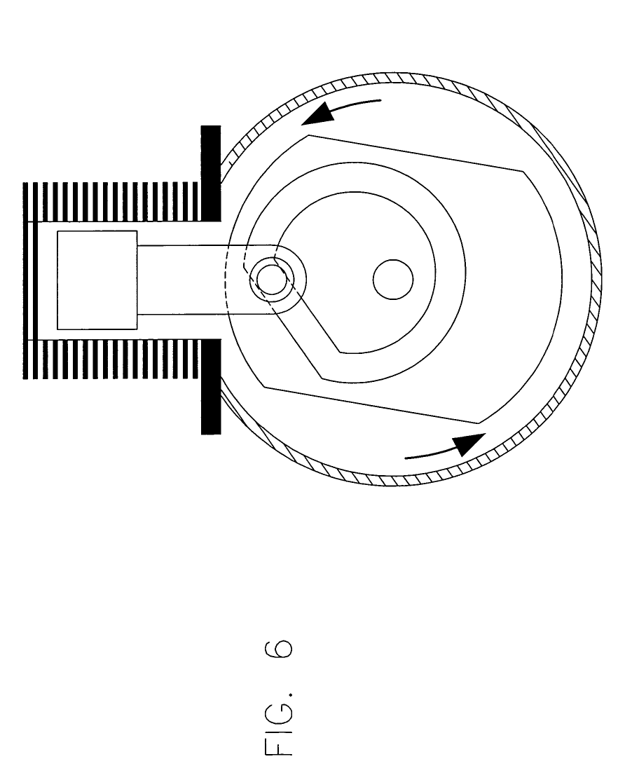

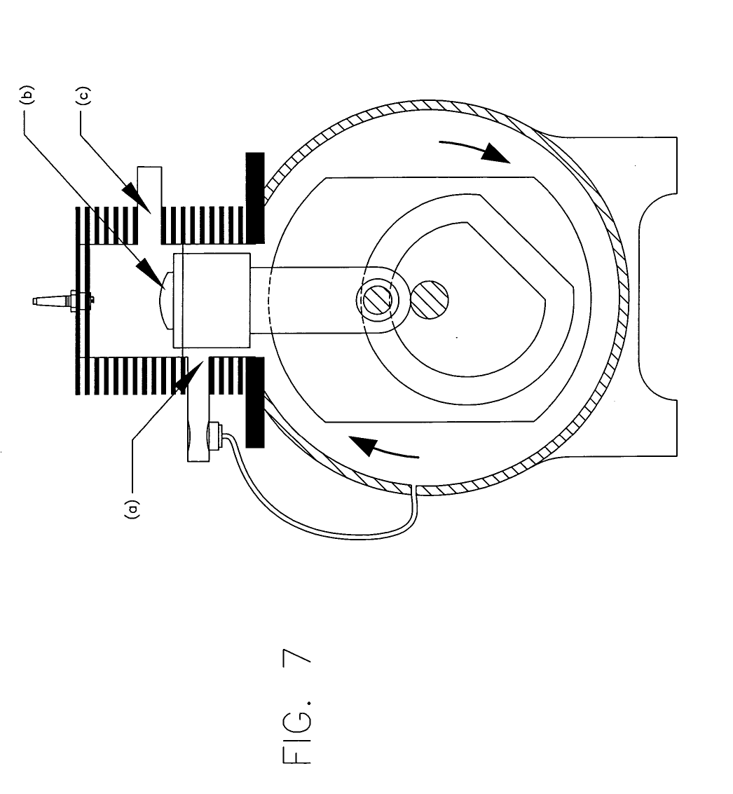

### FIELD OF INVENTION

The T.I.E. can be used in applications that are currently being used by conventional crankshaft geometry engines. The T.I.E. concept of increased torque efficiency can also be used in current compressor applications that would benefit from the same torque advantage. The manufacturing process of two components of the three major moving part components of the internal combustion engine, i.e., the piston and rod can be machined as a single unit and the wrist pin is eliminated. The offset disc involves no more complexity in the machining process than crank journals and throw arms. Lubrication is greatly simplified in the T.I.E. because crank journals are eliminated. Needle bearings that hold T.I.E.'s rod and follower pin in the offset disc are lubricated in an oil sump in the case of a four stroke design and piston walls can either be splash or pressure lubricated.

### DESCRIPTION OF THE RELATED ART

The internal combustion engine that is in common use incorporates a crankshaft to convert reciprocating motion to circular motion using three major moving parts: the piston, the crankshaft, and the wrist pin. There are inherent problems with this arrangement. First and foremost is the lack of convertible torque transmitted to the output axis of the crank shaft. When the pressure of the chemical explosion is at it's highest, i.e., when the piston is at top dead center and a few rotational degrees of the crankshaft thereafter. The necessity of initiating the explosion of the fuel air mixture at this point is due to the compression requirements of the same and is the root cause of the mechanical disadvantage inherent in the geometry of the crank shaft design. All the components for converting reciprocal motion to circular are essentially on the same perpendicular axis to the axis of the bore of the output shaft. If the peak of the explosive pressure between the cylinder head and piston face occurred when the crankshaft was at ninety (90) degrees of rotation past top dead center torque would be dramatically increased. This is what occurs in a bicycle when the cyclist can apply peak torque to the pedal in the vicinity of ninety degree rotation. Unfortunately the pressure applied to the piston face (90 degrees of rotation past top dead center) in the crankshaft geometry engine is zero. This geometry dictates that the “sweet spot” of torque, i.e., when pressure remains high and some leverage is being transmitted to the output shaft, be very brief and mechanically disadvantaged. When rotation of the crank significantly increases the leverage (around 20-60 degrees) the result is a proportionate decrease of pressure on the piston face due to the piston traveling down the bore of the cylinder thus increasing the volume between the piston face and the head. As leverage increases pressure decreases.

The T.I.E. addresses this problem by changing the mechanical geometry. By having a disc such that it rotates in an orbit around the axis of the output shaft it thereby increases the leverage at peak explosive pressure. If the disc is located at a greater distance from the output shaft leverage increases commensurately. However, if the disc incorporates an increased inclination to the axis of rotation of the output shaft the piston/rod leverage is increased. This increased incidence is only incorporated for the power stroke of the four stroke cycle. The disc reverts to a common radius (orbit) after 90 degrees rotation so as not to negatively effect the volumetric efficiency of the engine in that the time sequence for the exhaust, intake, and compression strokes remain the same. If would be nice if the force was exactly perpendicular to the axis of rotation of the output shaft. However, it is a tangenital force thus the force induced is decreased. However, due to the massive increase in leverage (three times) and the increased incidence (45 degrees) the result was a five-fold increase in leverage (torque) in test applications. It should be noted here in a crank shaft design, tangenital force rather than perpendicular also detracts from the torque induced. An even more dramatic reduction occurs when the rod swings further from the perpendicular axis of wrist pin and output shaft. The further the piston travels down the cylinder the angle of the between the wrist pin and crank journal increases accordingly. By using a 45 degree angle for the power stroke, the T.I.E. tangenital thrust remains relatively constant.

### DESCRIPTION OF THE PREFERRED EMBODIMENT

The specific improvement of the T.I.E. when compared to a crankshaft geometry engine is that torque is increased and thus horsepower and the ability to do work is increased for the same amount of fuel and air consumption. From a fuel standpoint, the T.I.E. is thus advantaged and the same holds true from air pollution concerns.

The parts involved are illustrated in drawings numbered 1 and 2 and a comparison drawing with a crankshaft engine is illustrated in drawing number 3. In drawings numbered 1 and 2, two mirror imaged parts are shown with a spacer between them to allow clearance for the drivingly connected rod and follower pin to pass between.

As to the manufacture of the tie, conventional or CNC metal working machine tools would be used as they are in crankshaft geometry engines.

What is claimed is:

1. (canceled)

2. An improved design of the mechanical parts of an internal combustion engine that are associated with the transmission of the thermodynamic energy imparted to the linear or reciprocal elements to the rotary motion required of an output shaft.

3. The engine of claim two whereby the 360 degree contour is such that the contours revert to a concentric radius of the offset for the remaining three strokes so as to not negatively effect the normal efficiency of the engine pertinent to the exhaust stroke, the volumetric efficiency on the intake stroke, and the mean effective pressure of the compression stroke.

4. The engine of claim two can accommodate additional pistons in an opposing or radial arrangement using the same contoured plates.

5. The engine of claim two is such that one moving part of the conventional crankshaft engine is eliminated, this part being the wrist pin, and that the machining of the piston/rod as a single piece adds to the relative rigidity of the system thus reducing vibration.

6. The engine of claim two is such that a mirror image contoured plate securely affixes the follower pin at the end of the rod thereby reducing sidereal forces on the pin and the need for additional rollers and/or guide pins, offset connecting rods, and elliptical shapes as evident in two previous patents (U.S.-2001/0017122A1 and U.S. Pat. No. 1,349,660).

7. The engine of claim two is such that the piston/rod combination is naturally balanced with the rod being machined to the center of the piston making an offset to said rod to accommodate a pin(s) that follows the contours unnecessary and allows for perpendicular forces that reduce unequal forces on reciprocating parts.

8. The engine of claim two is such that torque imparted to the output shaft during the power stroke is due to a geometry that imparts maximum leverage on the output shaft when the pressure from the thermodynamic energy is at its highest.

9. The engine of claim two is such that the exhaust, intake, and compression strokes are effected by a geometry that is concentric to a constant radius that would afford a smooth transition among those strokes.

10. The engine of claim two is of such configuration that the manufacturing costs of the parts for said engine would be less than conventional engines and substantially less than designs related to attempts at achieving a constant volume or constant pressure design.

11. The engine of claim two is devoid of eccentric contours that allow the rod pin or roller to follow thus mitigating vibration of the engine itself and decreasing manufacturing and maintenance costs.

12. The engine of claim two is so designed that a wide variation of piston size can be accommodated without necessitating an increase in the length of the reciprocal motion of the piston/rod.

13. The engine of claim two is so designed that all moving parts involved with the strokes of an engine are collinear with no offsets that would cause engine vibration, piston slap, and misalignment of a path followed by said roller or pin.

14. A compressor of claim two is identical in all respects to the engine of said claim except that the compression stroke is geometrically akin to the power stroke and possessive of the same geometric advantages inherent in the said design thereby lessening the power requirements on the input shaft.
